(19) United States
(12) Patent Application Publication
(10) Pub. No.: US 2025/0218357 A1
(43) Pub. Date: Jul. 3, 2025

(54) LIGHT EMITTING DEVICE, PHOTOELECTRIC CONVERSION DEVICE, ELECTRONIC DEVICE, LIGHTING DEVICE, AND MOVING OBJECT

(71) Applicant: CANON KABUSHIKI KAISHA, Tokyo (JP)

(72) Inventor: DAISUKE KOBAYASHI, Kanagawa (JP)

(21) Appl. No.: 18/999,542

(22) Filed: Dec. 23, 2024

(30) Foreign Application Priority Data
Dec. 27, 2023 (JP) 2023-221460

(51) Int. Cl. G09G 3/3225; F21S 43/145; F21Y 115/15; G03G 15/04; G09G 3/00; H04N 23/53

(52) U.S. Cl. CPC G09G 3/3225; F21S 43/145; F21Y 2115/15; G03G 15/04054; G09G 3/003; G09G 3/035; G09G 2310/0248; G09G 2310/027; G09G 2310/0291; G09G 2310/0294; G09G 2354/00; G09G 2380/10; H04N 23/53

(57) ABSTRACT

A light emitting device comprises a plurality of light emitting elements arranged in a plurality of rows and a plurality of columns, a signal output circuit configured to drive the plurality of light emitting elements, and a voltage generating circuit configured to output a set of voltage signals. The signal output circuit includes a plurality of column circuits configured to respectively drive a plurality of light emitting elements in a corresponding column among the plurality of columns. Each column circuit includes a voltage holding circuit configured to hold voltages corresponding to the set of voltage signals supplied from the voltage generating circuit and a digital-to-analog converter configured to convert an inputted digital signal to an analog signal using a voltage among the voltages held in the voltage holding circuit.

### BACKGROUND

### Technical Field

One disclosed aspect of the embodiments relates to a light emitting device, a photoelectric conversion device, an electronic device, a lighting device, and a moving object.

### Description of the Related Art

Some light emitting devices that include liquid crystal display elements or organic EL elements include a pixel portion constituted by pixels being arranged in a matrix and a driving circuit for driving the pixels. Some driving circuits are equipped with a digital interface driving circuit that includes a digital-to-analog converter (hereinafter, referred to as “DA converter”) as a driving circuit. Japanese Patent Laid-Open No. 2004-191536 describes a display device that includes a reference voltage selection type DA converter that selects a reference voltage by controlling switches based on inputted digital display data and converts the digital display data into an analog signal. In the display device disclosed in Japanese Patent Laid-Open No. 2004-191536, a plurality of reference voltage lines for supplying reference voltages to the DA converter are arranged.

### SUMMARY

According to one disclosed embodiment that has been made in consideration of the above-described disadvantage, it is possible to provide a light emitting device including a circuit that is advantageous for reducing a decrease in emission quality associated with a conversion operation of a DA converter in the light emitting device.

According to one aspect of the disclosure, there is provided a light emitting device. The light emitting device comprises a plurality of light emitting elements arranged in a plurality of rows and a plurality of columns, a signal output circuit configured to drive the plurality of light emitting elements, and a voltage generating circuit configured to output a set of voltage signals. The signal output circuit includes a plurality of column circuits configured to respectively drive a plurality of light emitting elements in a corresponding column among the plurality of columns. Each column circuit includes a voltage holding circuit configured to hold voltages corresponding to the set of voltage signals supplied from the voltage generating circuit and a digital-to-analog converter configured to convert an inputted digital signal to an analog signal using a voltage among the voltages held in the voltage holding circuit.

Further features of the present disclosure will become apparent from the following description of exemplary embodiments with reference to the attached drawings.

### BRIEF DESCRIPTION OF THE DRAWINGS

FIG. 1 is a block diagram of a light emitting device according to a first embodiment;

FIG. 2 is an equivalent circuit diagram of a voltage generating circuit according to the first embodiment;

FIG. 3 is an equivalent circuit diagram of a DA converter for a comparative example;

FIG. 4 is an equivalent circuit diagram of a voltage holding circuit and a DA converter according to the first embodiment;

FIG. 5 is an operation timing diagram of a signal output circuit according to the first embodiment;

FIG. 6 is another operation timing diagram of the signal output circuit according to the first embodiment;

FIG. 7 is a diagram for explaining other control of the voltage holding circuit according to the first embodiment;

FIG. 8 is an equivalent circuit diagram of the voltage holding circuit and the DA converter according to a second embodiment;

FIG. 9 is an operation timing diagram of the signal output circuit according to the second embodiment;

FIG. 10 is an equivalent circuit diagram of the voltage holding circuit and the DA converter according to a third embodiment;

FIG. 11 is an equivalent circuit diagram of the voltage holding circuit and the DA converters according to a fourth embodiment;

FIG. 12 is an equivalent circuit diagram of the voltage holding circuit and the DA converter according to a fifth embodiment;

FIG. 13 is another equivalent circuit diagram of the voltage holding circuit according to the fifth embodiment;

FIG. 14 is an equivalent circuit diagram of the voltage holding circuit and the DA converters according to a sixth embodiment;

FIG. 15A is a schematic cross-sectional diagram illustrating an example of a pixel of a display device according to one embodiment of the present disclosure;

FIG. 15B is a schematic cross-sectional diagram of an example of the display device, in which an organic light emitting element is used, according to one embodiment of the present disclosure;

FIG. 16 is a schematic diagram illustrating an example of the display device according to one embodiment of the present disclosure;

FIG. 17A is a schematic diagram illustrating an example of an image capturing device according to one embodiment of the present disclosure;

FIG. 17B is a schematic diagram illustrating an example of an electronic device according to one embodiment of the present disclosure;

FIG. 18A is a schematic diagram illustrating an example of the display device according to one embodiment of the present disclosure;

FIG. 18B is a schematic diagram illustrating an example of a foldable display device;

FIG. 19A is a schematic diagram illustrating an example of a lighting device according to one embodiment of the present disclosure;

FIG. 19B is a schematic diagram illustrating an example of a vehicle that includes a vehicle lamp according to one embodiment of the present disclosure;

FIG. 20A is a schematic diagram illustrating an example of a wearable device according to one embodiment of the present disclosure;

FIG. 20B is a schematic diagram illustrating an example of the wearable device according to one embodiment of the present disclosure in a form in which an image capturing device is included;

FIG. 21A is a schematic diagram of an image forming device according to one embodiment of the present disclosure;

FIG. 21B is a schematic diagram illustrating a form in which a plurality of light emitting units of an exposure light source are arranged on a long substrate; and

FIG. 21C is a schematic diagram illustrating a form in which a plurality of light emitting units of an exposure light source are arranged on a long substrate.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but limitation is not made to an embodiment that requires all such features, and multiple such features may be combined as appropriate. Furthermore, in the attached drawings, the same reference numerals are given to the same or similar configurations, and redundant description thereof is omitted.

### First Embodiment

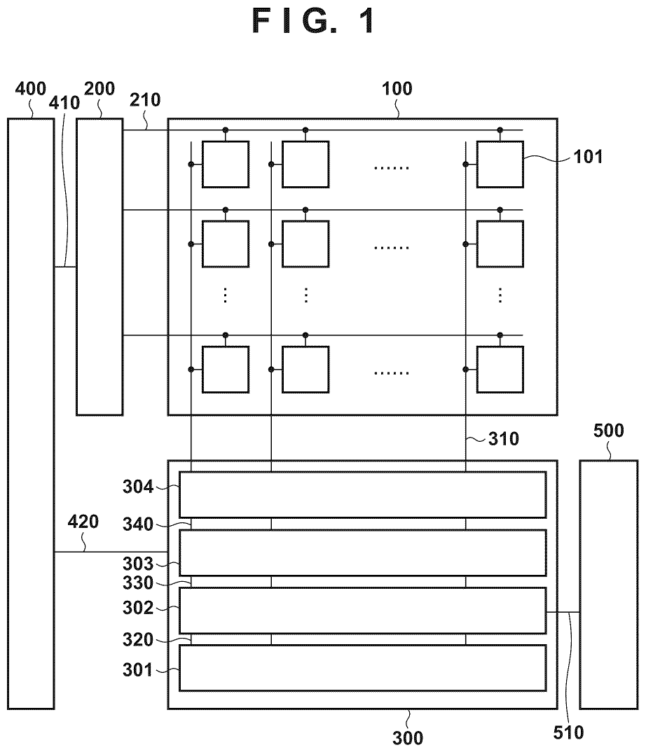

Embodiments of a light emitting device according to the present disclosure will be described with reference to FIGS. 1 to 7. The following embodiments all illustrate examples of the present disclosure, and numerical values, shapes, materials, components, arrangement and connection forms of components, and the like do not limit the invention. Further, in the embodiments to be described below, a display device that takes image data as an input signal will be mainly described as an example of the light emitting device. However, the light emitting device according to each of the embodiments is not limited to a display device. Examples in which the light emitting device according to the present embodiment is used include a lighting device and a lamp.

FIG. 1 is a block diagram illustrating one form of the light emitting device according to the present embodiment. In a pixel array 100, a plurality of pixels 101 are arranged two-dimensionally (here, in a matrix) over a plurality of rows and a plurality of columns. Regarding each pixel 101, a control signal is inputted from a vertical scanning circuit 200 via a scanning line 210, and a luminance signal voltage corresponding to an image signal is inputted from a signal output circuit 300 via a signal line 310. The vertical scanning circuit 200 and the signal output circuit 300 are controlled by a control circuit 400 via control lines 410 and 420. The pixel 101 includes, for example, an organic light emitting element (referred to as an organic electroluminescent element or an organic light emitting element) as a light emitting element and emits light in a light emission amount corresponding to an inputted luminance signal voltage. Here, the pixel is not limited to that including an organic light emitting element. So long as light emission of the pixel is controlled according to an inputted voltage, the pixel may include a light emitting diode or a liquid crystal element. Each pixel 101 may include a plurality of sub-pixels arranged for respective colors, in which case the signal line 310 may be arranged for each sub-pixel column that is based on each sub-pixel. For example, when one pixel includes three sub-pixels, three signal lines 310 may be arranged for one pixel column.

The signal output circuit 300 includes a horizontal scanning circuit 301 and voltage holding circuits 302, DA converters 303, and driver circuits 304, which are arranged over a plurality of columns. In the present embodiment, when the number of columns is n, one voltage holding circuit 302-m (where m is an integer of 1 or more and n or less), one DA converter 303-m, and one column driver circuit 304-m are arranged for each of the respective columns. The voltage holding circuit 302-m, the DA converter 303-m, and the column driver circuit 304-m are included in a column circuit for processing one column's worth of signal for an m-th column.

The horizontal scanning circuit 301 scans each column and supplies image data corresponding to a luminance signal voltage to each column via a DA converter control line 320. The image data inputted via the DA converter control signal line 320 is converted into an analog voltage by the voltage holding circuit 302 and the DA converter 303. This analog voltage is inputted to the driver circuit 304 via a DA converter output line 340. The analog voltage inputted from the DA converter 303 is outputted via the column driver circuit 304. A voltage generating circuit 500 generates a set of voltage signals Vref, the number thereof corresponding to a bit width of the image data (256 analog voltages if the image data is an 8-bit digital signal), and supplies them to the signal output circuit 300 via voltage signal lines 510. The voltage generating circuit 500 may also generate a reference voltage to be used in variation correction for the signal output circuit 300 and the pixels 101. The reference voltage for correction at this time may be supplied to the pixels 101 via the column driver circuits 304 and the signal lines 310.

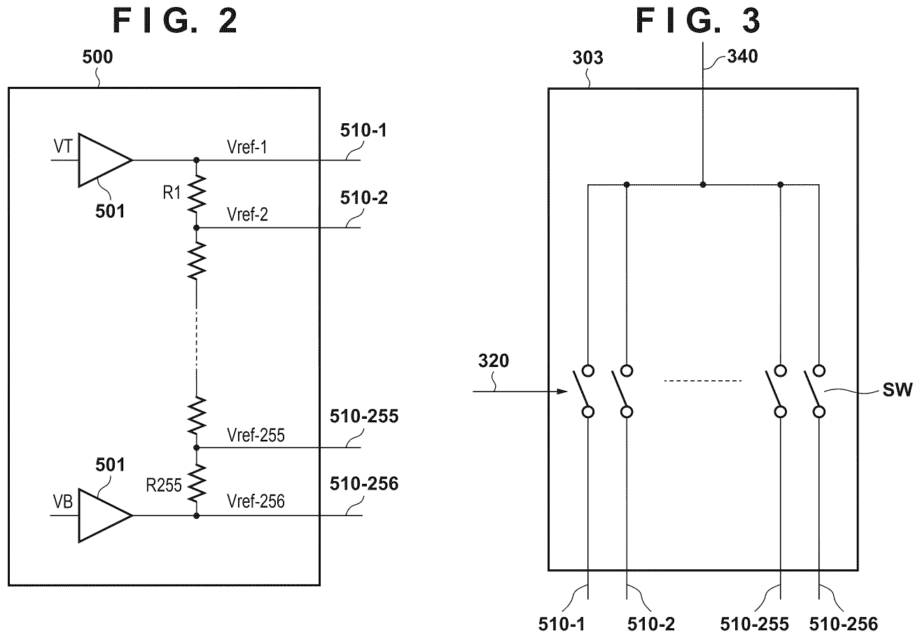

FIG. 2 is an equivalent circuit diagram of the voltage generating circuit 500 according to the present embodiment and is an example of a configuration in which image data is 8 bits. 256 voltage signals Vref (Vref-1 to Vref-256) are generated by a resistor string constituted by resistors R1 to R255 between a reference voltage VT and a reference voltage VB and are outputted via the voltage signal lines 510. The reference voltage VT and the reference voltage VB may be supplied from outside the light emitting device or may be generated inside the light emitting device. In the present embodiment, a configuration is taken such that the reference voltage VT and the reference voltage VB generated by a reference voltage generating circuit (not illustrated) are applied to the resistor string via buffer circuits 501. One voltage signal Vref is selected according to image data of a respective column and is outputted to the column driver 304.

For comparison with the present embodiment, a column circuit for a comparative example will be described with reference to FIG. 3. The plurality of voltage signal lines 510 (510-1 to 510-256) are connected to the DA converter 303 without going through the voltage holding circuit 302 illustrated in FIG. 1. Image data corresponding to a luminance signal is supplied to a decoder circuit (not illustrated) in the DA converter 303. A bit value held by the image data is supplied to the DA converter via the DA converter control line 320 and is decoded to control switches SW. For example, when the image data is an 8-bit digital signal, the decoder controls the switches SW based on the 8-bit digital signal, selects a voltage signal Vref corresponding to the image data from among 256(equivalent to 8 bits) voltage signals.

At this time, when conversion operation by the plurality of DA converters arranged so as to correspond to the columns of pixels take place, the potentials of wires for supplying the voltage signals, which serve as references for conversion, to the DA converters may fluctuate. Further, switching noise associated with the DA conversion operation may be generated. The potential variation and noise result in crosstalk between the columns and may cause a decrease in light emission quality.

Specifically, the voltage signal Vref selected by the switch SW transiently fluctuates in potential due to a potential difference with the DA converter output line 340, switching noise caused by operation of the switch SW, coupling capacitance with the DA converter control signal line 320 for controlling the switch, and the like. For the voltage signal Vref from the voltage signal line 510 to settle, a response time based on a time constant determined by a resistance value of the resistor string, the wiring parasitic resistance and the wiring parasitic capacitance of the voltage signal line 510, input parasitic capacitance of the column driver circuit 304, and the like is necessary. Further, since the voltage signals Vref are shared by the plurality of column DA converters 303, the same voltage signal Vref may be selected in a plurality of columns depending on the image data. The greater the number of DA converters 303 that are simultaneously selected, the greater the amount of transient potential variation associated with the DA conversion operation of the DA converters 303, and the input parasitic capacitance of the driver circuit 304 increases with the number of columns, and so, the necessary settling time increases.

If the settling time is not sufficient, it may cause a situation in which operation at an accurate level of light emission that is based on image data cannot be performed. Further, when there are a plurality of columns of DA converters 303 that have selected the same voltage signal Vref, operation at an accurate level of light emission cannot be performed. For example, horizontal banding and horizontal smearing, which are representative examples of the influence of crosstalk between the column circuits, may be observed. These decrease the quality of an emitted image.

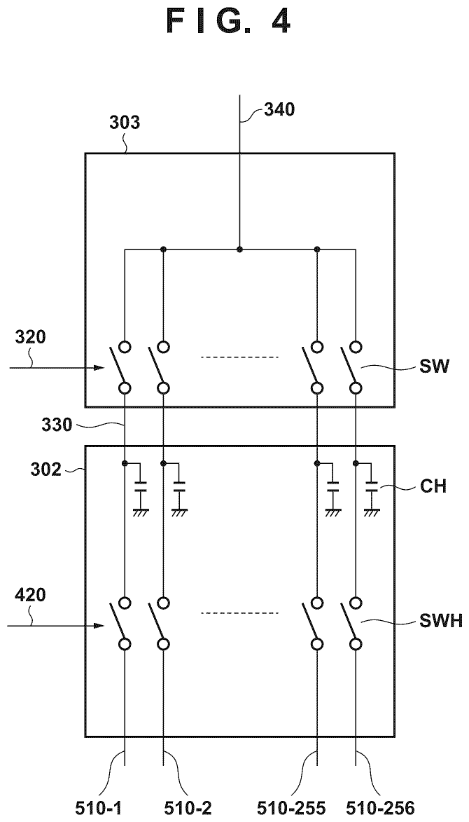

FIG. 4 is an equivalent circuit diagram of the voltage holding circuit 302 and the DA converter 303 of the signal output circuit 300 for one column according to the present embodiment. Compared to FIG. 3, the voltage signal lines 510 are connected to the voltage holding circuit 302, and the plurality of voltage signal Vref are supplied to the column DA converter 303 via holding voltage output lines 330. The voltage holding circuit 302 includes switches SWH, which are controlled according to the control signal 420, and holding capacitors CH. The holding capacitor CH may be constituted by a capacitor element, such as a metal oxide semiconductor (MOS) capacitor or a metal insulator metal (MIM) capacitor. The switches SWH can control connections between the voltage generating circuit 500 and the holding capacitors CH and can connect or disconnect the voltage generating circuit 500 and the holding capacitors CH.

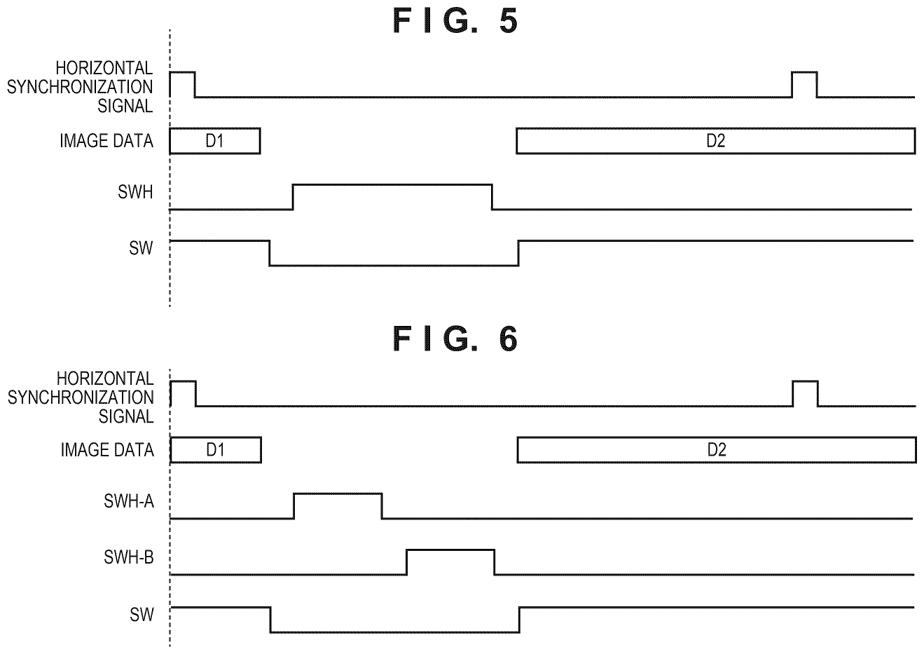

FIG. 5 is a diagram for explaining operation timings for the voltage holding circuit 302 and the column DA converter 303 of FIG. 4 and illustrates a horizontal synchronization signal indicating periods of row scanning cycles, switching of image data D1 and D2, and operation timings for the switches SWH and the switches SW. It illustrates that the image data D2, which has been inputted during one cycle of the horizontal synchronization signal, is converted into an analog voltage by the DA converter. It is assumed that the switches SWH and the switches SW are on when the control signal is high and off when the control signal is low. Hereinafter, it is assumed to be similar for other switches.

In an operation for one row, the switches SW are controlled based on the image data D1 of a previous row, and after the switches SW are turned off, the switches SWH are turned on to connect respective holding capacitor CH with the respective corresponding voltage signal lines 510. The switches SWH are turned off and the voltage signals Vref are held in the holding capacitors CH. With this, the connections between the holding capacitors CH and the voltage signal lines 510 are disconnected, and the voltage signals Vref are held in the holding capacitors CH.

Once the voltage signals Vref are held in the holding capacitors CH, a switch SW is controlled to be turned on according to the image data D2 at a timing for DA conversion of the image data D2 of the next row, that is, before the next horizontal synchronization signal becomes high. With this operation, an analog voltage corresponding to the image data D2 is selected by the switch SW and outputted to the driver circuit 304. When the switch SW is turned on according to the image data D2, the voltage signal lines 510 and the holding capacitors CH are disconnected by the switches SWH. Therefore, even when the same voltage signal Vref is selected among the column DA converters 303, it is possible to reduce crosstalk among the column DA converters 303. Further, parasitic load of the DA converter output line 340 can also be reduced compared to the configuration of FIG. 3. With this, the level of dependence of a settling time for transient variation associated with the operation of the column DA converters 303 on an increase in the number of pixels or the pattern of the image data can be reduced, and a decrease in the quality of an emitted image can be reduced. A capacitance value that a capacitor element constituting a holding capacitor CH has is set taking into account a light emission period, a settling period, and an allowed time constant as indicators.

FIG. 6 is a diagram for explaining other operation timings of the voltage holding circuit 302 of FIG. 4. Switches SWH-A and SWH-B indicate that the switches SWH of the voltage holding circuit 302 are controlled at different timings. For example, the switches SWH are controlled in a shifted manner in units of a plurality of columns, such as respective even columns and respective odd columns, and the voltage signals Vref are held in the holding capacitors CH. Switching noise caused by simultaneous operation of all columns of the switches SWH can cause transient variation in the voltage signals Vref, and so, by spreading the operation timings of the switches SWH, the switching noise can be reduced. In this example, an example in which there are two different timings has been described. The number of different timings may be increased from 2. The number of timings can be determined by taking into account the settling time of the holding capacitor.

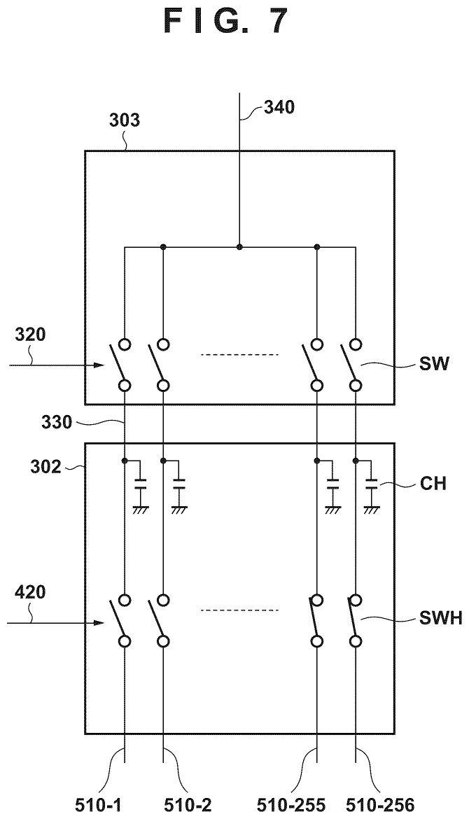

FIG. 7 is a diagram illustrating other control of the voltage holding circuit 302. The switches SWH are arranged for the plurality of voltage signals Vref supplied to the respective columns, and for example, the switches SWH are controlled differently for respective voltage signals Vref. In FIG. 7, the switches SWH connected to the voltage signal lines 510-1 and 510-2 are controlled to be turned on and off as in FIGS. 5 and 6, and the switches SWH connected to the voltage signal lines 510-255 and 510-256 are always on. Crosstalk may be less noticeable at the time of particular luminance light emission, such as at the time of high luminance light emission. In FIG. 7, by controlling the switches SWH to be in an on state for the voltage signal lines 510-255 and 510-256 to which voltage signals Vref corresponding to particular luminances are connected, it is possible to attempt to reduce power and switching noise associated with the switching operation. Further, a configuration may be taken so as not to arrange a holding capacitor CH and a switch SWH on the wire of a particular voltage signal Vref.

As described above, in the present embodiment, the voltage signals Vref shared by the plurality of column DA converters 303 are held in the holding capacitors CH, each including a capacitor element in the configuration, provided in the voltage holding circuit 302. Then, the voltage signal Vref to be inputted to the driver circuit 304 via the DA converter output line 340 is selected in the column DA converter 303 based on image data. With this configuration, it is possible to reduce crosstalk between the column DA converters 303 via the voltage signal lines 510 associated with the operation of the column DA converters 303. Further, it is possible to reduce the amount of transient variation in the voltage signal Vref and necessary settling time, and so, it is possible to improve the quality of an emitted image without dependency on an increase in the number of pixels or a pattern of the image.

### Second Embodiment

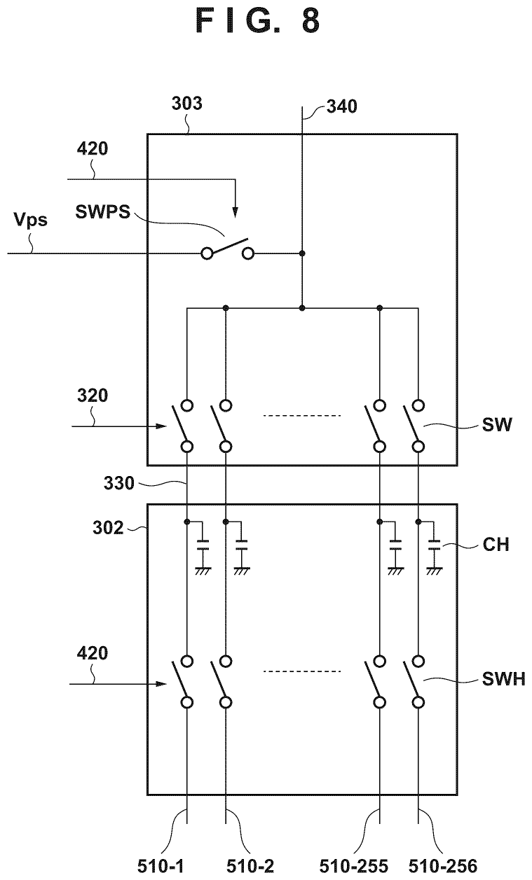

FIG. 8 is an equivalent circuit diagram of a voltage holding circuit 302 and a column DA converter 303 according to the present embodiment. In the present embodiment, a configuration includes a pre-charge circuit for supplying a preset voltage Vps in which a switch SWPS is connected to the DA converter output line 340 of the column DA converter 303 of the first embodiment. Description will be given focusing on points of difference from the first embodiment.

In the first embodiment, the voltage signal Vref held in the holding capacitor CH is outputted to the DA converter output line 340 via the switch SW. Assuming that parasitic capacitance of the DA converter output line 340 is Cp, a capacitance of the holding capacitor CH is C_{cH}, a potential held on the DA converter output line 340 prior to the switch SW being turned on is Vp, a potential V_{DA} of the DA converter output line 340 after the switch SW is turned on will be as in Equation (1) below.

$${V}_{DA} = ( {C}_{cH} + Vref + Cp \times Vp ) / ( {C}_{cH} + Cp ) \qquad ( 1 )$$

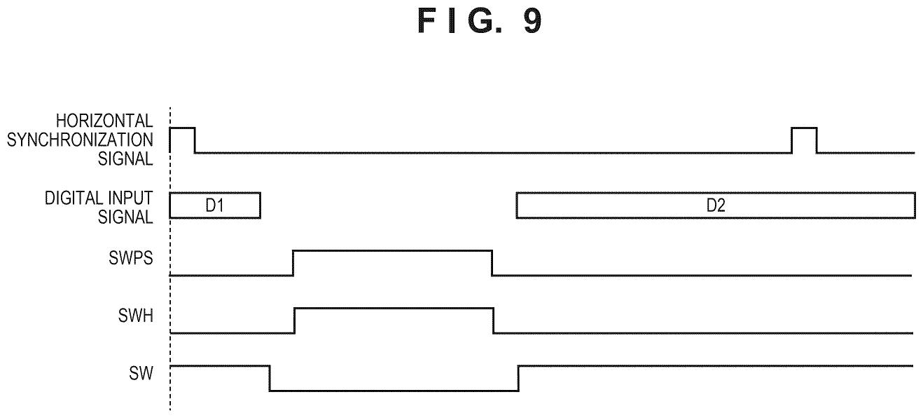

Since the potential Vp is a potential that can change based on the image data, a relationship between the potential Vp and the voltage signal Vref may not always be constant. This means that in response to a change in a voltage signal corresponding to particular image data, the luminance signal voltage fluctuates due to the influence of the potential Vp which may cause variation in the light emission luminance. FIG. 9 is a diagram for explaining operation timings of the column DA converter 303 of FIG. 8.

A configuration is taken so as to control the switch SWPS according to the control signal 420 similarly to the switches SWH, but a configuration may be taken so as to perform control according to another control signal or timing. The switch SWPS is turned on while the switches SWH are on and the switches SW are off to supply the preset voltage Vps to the DA converter output line 340. After the switches SWH and the switch SWPS are turned off, a switch SW is turned on. With this, before the switch SW is turned on, the parasitic capacitance Cp can be pre-charged to a predetermined voltage. By pre-charging, the potential V_{DA} of the DA converter output line 340 will be as in Equation (2).

$${V}_{DA} = ( CH \times Vref + Cp \times Vps ) / ( {C}_{cH} + Cp ) \qquad ( 2 )$$

The preset voltage Vps is a constant voltage and can thus reduce variation in luminance in response to a change of the voltage signal according to particular image data. When the preset voltage Vps set to, for example, a value that is in the middle of a set of voltage signals, a voltage change for when the switch SW is turned on can be averaged.

As described above, in the present embodiment, the DA converter output line 340 is set to the preset voltage Vps before the image data to be inputted is switched to the next image data. By doing so, a relationship between the potential held in the DA converter output line 340 before a switch SW is turned on and the voltage signal Vref will be constant. With this, it is possible to obtain an effect similar to that of the first embodiment and reduce a variation in luminance for each emission corresponding to image data.

### Third Embodiment

FIG. 10 is an equivalent circuit diagram of the voltage holding circuit 302 and the column DA converter 303 according to the present embodiment. In the present embodiment, a configuration is taken so as to arrange buffer circuits 305 in the voltage holding circuit 302 of the first embodiment and output the voltage signal Vref held in the holding capacitor CH via the buffer circuit 305. Description will be given focusing on points of difference from the first embodiment.

As described in the second embodiment, due to the relationship between the voltage signal Vref and the potential Vp held by the DA converter output line 340, light emission luminance may change in response to a change in particular image data. This is because the potential of the DA converter output line 340 is determined by capacitive division according to the parasitic capacitance Cp and the holding capacitor CH. In the present embodiment, the voltage signal Vref held in the holding capacitor CH is supplied to the DA converter output line 340 via the buffer circuit 305. With this, the DA converter output line 340 may take on a constant voltage signal Vref based on image data, independent of parasitic capacitance Cp and potential Vp.

As described above, in the present embodiment, the voltage signal Vref held in the holding capacitor CH is supplied to the DA converter output line 340 via the buffer circuit 305. By it going through the buffer circuit, it is possible to obtain an effect similar to that of the first embodiment and perform favorable light emission for image data.

### Fourth Embodiment

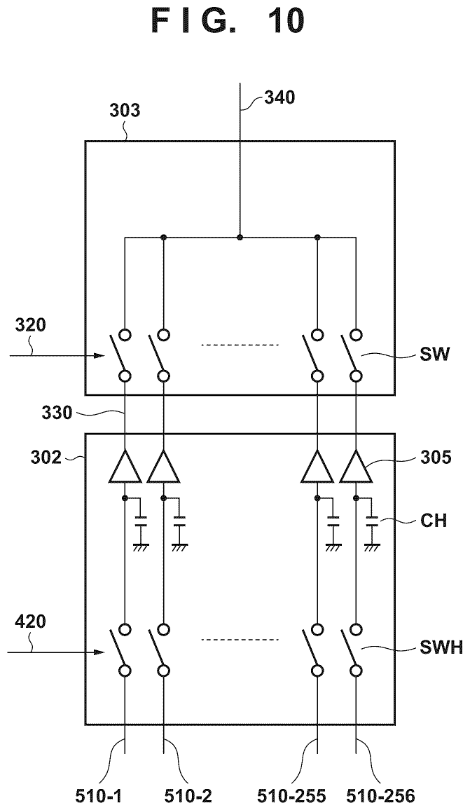

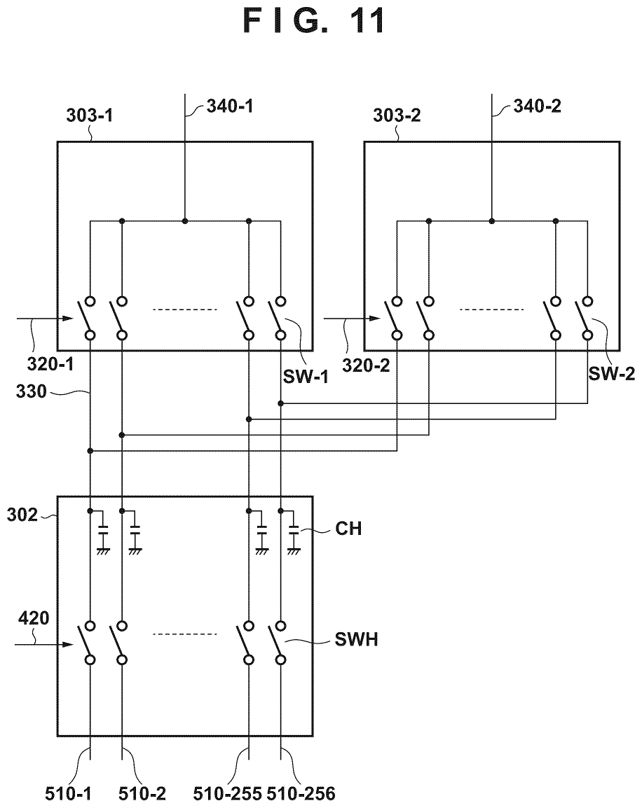

FIG. 11 is an equivalent circuit diagram of the voltage holding circuit 302 and two columns of DA converters 303-1 and 303-2 according to the present embodiment. In the present embodiment, regarding the arrangement of the voltage holding circuits 302 and the column DA converters 303 of the first embodiment, a configuration is taken such that two column DA converters 303 share one voltage holding circuit 302. Description will be given focusing on points of difference from the first embodiment.

In the first embodiment, a configuration is taken so as to arrange one voltage holding circuit 302 with one column DA converter 303, and it is necessary to arrange as many switches SW, switches SWH, and holding capacitors CH as the number of voltage signals Vref corresponding to the number of bits of the image data and the number of columns. Therefore, a proportion that the surface area of the voltage holding circuits 302 and the column DA converters 303 occupies in the surface area of the signal output circuit 300 may increase. In addition, for example, when increasing the number of bits of the voltage signals Vref, it is necessary to double the number of switches SW and SWH and holding capacitors CH each time one bit is added, which can cause an increase in chip size. Alternatively, even when reducing the pixel size, it is necessary to reduce the voltage holding circuits 302 and the column DA converters 303 in a horizontal direction, thereby increasing the vertical size of the signal output circuit 300, which can cause an increase in chip size.

In the present embodiment, by two column DA converters 303-1 and 303-2 sharing the voltage holding circuit 302, it is possible to halve the surface area of the voltage holding circuits 302 occupying the signal output circuit 300 as compared with the first embodiment. Further, regarding an increase in the number of bits of voltage signals Vref and a reduction in pixel size, it is possible to reduce an increase in chip size as compared with the first embodiment. In the present embodiment, a configuration is taken such that two column DA converters 303 share one voltage holding circuit 302, but a configuration may be taken such that three or more column DA converters 303 share the voltage holding circuit 302. Further, an arrangement relationship of the column DA converters 303 sharing the voltage holding circuit 302 may be configured such the column DA converters 303 share the voltage holding circuit 302 at a particular periodicity, such as for a plurality of respective adjacent columns, for respective even columns, and for respective odd columns.

As described in the first embodiment, when sharing the voltage signals Vref among the plurality of column DA converters 303, if there are a large number of column DA converters 303 that have selected the same voltage signal Vref, transient variation in the voltage signal Vref due to the switch SW will be large. Similarly, a plurality of column DA converters 303 sharing the voltage holding circuit 302 may cause crosstalk between the column DA converters 303 and may cause transient variation in the voltage signal Vref. In the configuration of the present embodiment, it is desirable that the capacitance value of the capacitor elements and the number of column DA converters 303 to be sharing the voltage holding circuit 302 be determined taking into account the allowable amount of transient variation and the settling time. Alternatively, the numbers of column DA converters 303 sharing the voltage holding circuit 302 and the arrangement relationship among the column DA converters 303 sharing the voltage holding circuit 302 may be determined such that horizontal banding and horizontal smearing are not visible, in view of the quality of an emitted image.

As described above, in the present embodiment, by a plurality of column DA converters 303 sharing one voltage holding circuit 302, it is possible to obtain an effect similar to that of the first embodiment and reduce an increase in chip size.

### Fifth Embodiment

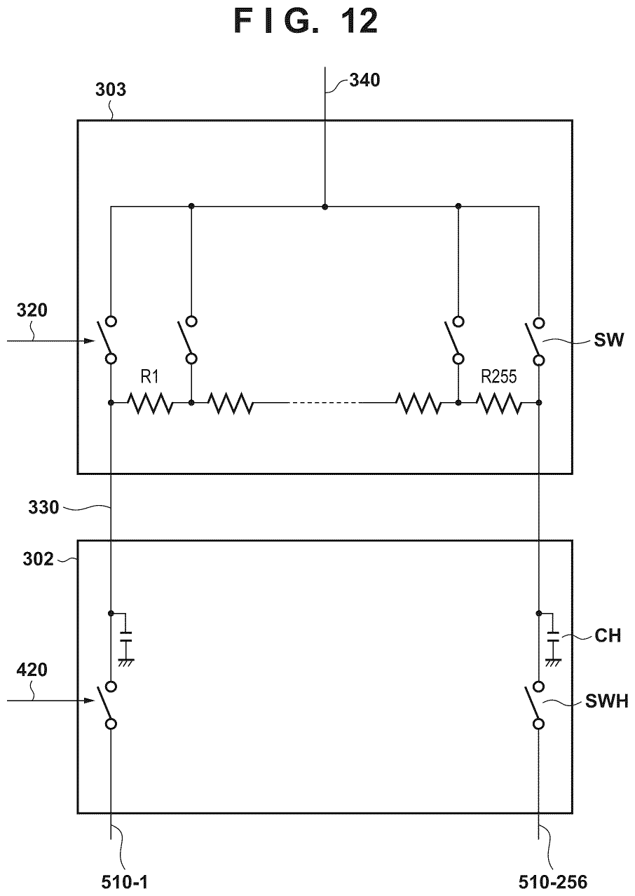

FIG. 12 is an equivalent circuit diagram of the voltage holding circuit 302 and the column DA converter 303 according to the present embodiment. In the present embodiment, in contrast to the voltage holding circuits 302 and the column DA converters 303 according to the first embodiment, a configuration is taken so as to connect the voltage signal lines 510-1 and 510-256 to the voltage holding circuit and arrange a resistor string in the column DA converter 303. Description will be given focusing on points of difference from the first embodiment.

In the first embodiment, the plurality of voltage signals Vref are generated in the voltage generating circuit 500. In the present embodiment, the voltage signals Vref-1 and Vref-256 are held in the holding capacitors CH, and the two voltage signals inputted to the DA converter 303 are divided by a resistor string to generate the plurality of voltage signals Vref-2 to Vref-255. The switches SW to be selected according to the image data inputted into the decoder are connected to nodes of the resistor strings from which corresponding voltage signals Vref are generated.

In the first embodiment, the plurality of voltage signals Vref are supplied to the column DA converters 303 in all columns by the plurality of voltage signal lines 510. As described in the first embodiment, the settling time for transient variation in the voltage signal Vref is determined by a time constant according to resistance and capacitance components, which include those of the resistor string in the voltage generating circuit 500 and the wiring parasitic resistance and the wiring parasitic capacitance of the voltage signal line 510. Therefore, it is necessary to reduce the resistance value of the resistor string in the voltage generating circuit 500. Similarly, it is necessary to increase the wiring widths of the voltage signal lines 510 for low resistance and increase the space between wires to reduce parasitic capacitance, which may cause an increase the chip size. In addition, similarly to the fourth embodiment, when increasing the number of bits of the voltage signals Vref, it is necessary to increase the number of wires of the voltage signal lines 510, which may cause an increase in chip size.

In the present embodiment, by arranging a resistor string in the column DA converter 303, there need only be two wires for the voltage signal lines 510, and a wiring surface area can be reduced. Further, since it is possible to increase the resistance of the resistor string itself, it is possible to make the resistive elements smaller in view of accuracy and allowable amount of current per unit of resistance, and even if a resistor string is arranged in each column DA converter 303, it is possible to reduce an increase in surface area and power consumption. A configuration may be taken such that a plurality of columns share the resistor string arranged in the DA converter 303 and the voltage holding circuit 302 as in the fourth embodiment. In this case, the numbers of DA converters 303 sharing the voltage holding circuit 302 can be determined, for example, taking into account the quality of an emitted image and power consumption. Further, regarding the switches SWH respectively arranged for the voltage signal line 510-1 and the voltage signal line 510-2, one or both may be controlled to be turned on and off or may be controlled to always be on, as in the first embodiment illustrated by FIG. 7.

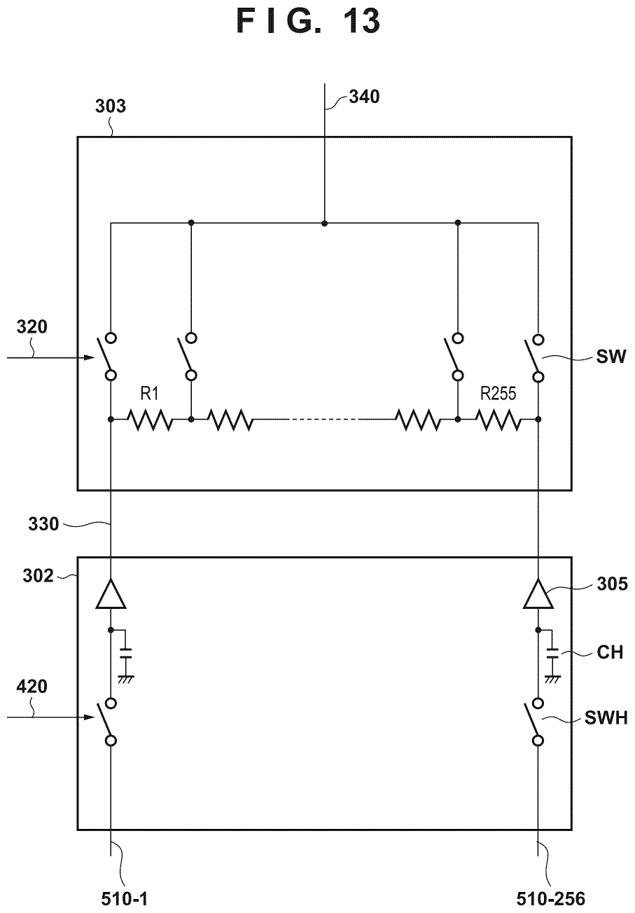

FIG. 13 is another equivalent circuit diagram of a voltage holding circuit 302 and a column DA converters 303 according to the present embodiment, and a configuration may be taken so as to arrange buffer circuits 305 in the voltage holding circuit 302 as in the third embodiment.

As described above, in the present embodiment, a resistor string is arranged in the column DA converter 303 to divide voltages supplied from a voltage holding circuit and generate a plurality of voltage signals Vref in the column DA converter 303. By dividing voltages in the DA converter 303, the number of wires of the voltage signal lines 510 can be reduced. With this, it is possible to obtain an effect similar to that of the first embodiment and reduce an increase in chip size.

### Sixth Embodiment

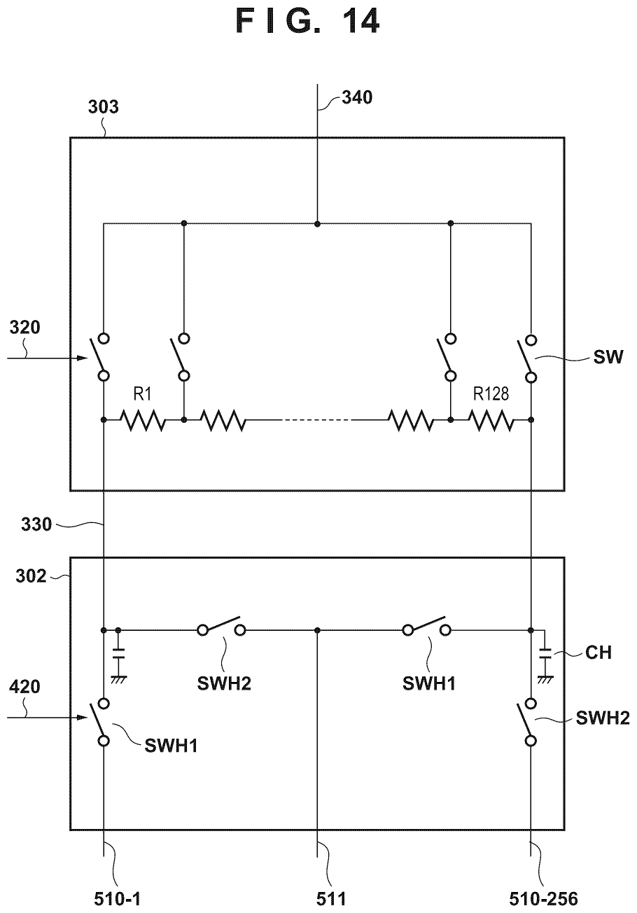

FIG. 14 is an equivalent circuit diagram of the voltage holding circuit 302 and the column DA converter 303 according to the present embodiment. In the present embodiment, in contrast to the fifth embodiment, voltage signal lines 510-1, 510-256, and 511 are connected to the voltage holding circuit 302 to supply three levels of different voltages, and switches SWH1 and SWH2 are arranged. Further, a configuration is taken so as to arrange a resistor string constituted by resistors R1 to 128 in the column DA converter 303. Description will be given focusing on points of difference from the fifth embodiment.

In the fifth embodiment, the voltage signals Vref-2 to 255 are generated by the voltage signals Vref-1 and Vref-256 and a resistor string. In this configuration, when increasing the number of bits of the voltage signals Vref, the number of resistors and switches SW increase exponentially, and the surface area of the column DA converter 303 increases.

In the present embodiment, the switches SWH1 and SWH2 are controlled in first mode or second mode according to the image data. The voltage signal line 511 is configured to supply an intermediate potential between the reference voltages VT and VB. In the first mode, the switches SWH1 are turned on and the switches SWH2 are turned off to generate voltage signals Vref with the voltage signal line 510-1, the voltage signal line 511 and the resistor string. In the second mode, the switches SWH2 are turned on and the switches SWH1 are turned off to generate voltage signals Vref with the voltage signal line 510-256, the voltage signal line 511 and the resistor string. With the configuration of the present embodiment, if the number of bits of the voltage signals Vref is 8 bits as in the fourth embodiment, the number of resistors of the resistor string and the number of switches SW can be approximately halved, from 255 to 128 and from 256 to 128, respectively, relative to the fourth embodiment. Normally, the resistance values of the resistors used in the resistor string are all designed to be R. However, in order to maintain an 8-bit monotonic increase, a configuration may be taken so as to able to change the resistance value of the resistor R128 to R/2 in the first mode and the resistance value of the resistor R1 to R/2 in the second mode. Alternatively, a configuration may be taken so as to be able to change the reference voltage supplied from the voltage signal line 511 according to the first and second modes. Further, in the present embodiment, regarding control of the switches SW, SWH1 and SWH2, a configuration is taken so as to be able to switch the mode in the control circuit 400 according to the image data and control the horizontal scanning circuit 301.

In the present embodiment, a configuration is taken so as to connect three voltage signal lines 510-1, 510-256, and 511 to generate voltage signals Vref with three reference voltages, but a configuration may be taken so as to generate voltage signals Vref with four or more reference voltages. Further, a configuration may be taken so as to arrange buffer circuits 305 between the holding capacitors CH and the resistor string as in the third embodiment.

As described above, in the present embodiment, by generating voltage signals Vref by a combination of three reference voltages and the resistor string constituted by the resistors R1 to 128, it is possible to reduce the number of resistors R constituting the resistor string and the number of switches SW. With this, it is possible to obtain an effect similar to that of the first and fifth embodiments and further reduce an increase in chip size relative to the fifth embodiment.

### Organic Light Emitting Element

The light emitting device described in the above first to sixth embodiments can be used as a constituent member of a display device or a lighting device of a device by capitalizing on light emission characteristics thereof. An example of application of the light emitting device according to the present embodiment will be described below, but prior to that, an example of a configuration of an organic light emitting element will be described in detail as an example of the light emitting element.

An organic light emitting element that may be used in the light emitting device according to the present embodiment will be described. An organic light emitting element according to the present embodiment includes a first electrode and a second electrode, and an organic compound layer arranged between these electrodes. Regarding the first electrode and the second electrode, one is an anode and the other is a cathode. In the organic light emitting element according to the present embodiment, the organic compound layer may be a single layer or may be a laminate constituted by a plurality of layers so long as a light emitting layer is included. Here, when the organic compound layer is a laminate constituted by a plurality of layers, the organic compound layer may include, in addition to the light emitting layer, a hole injection layer, a hole transport layer, an electron blocking layer, a hole exciton blocking layer, an electron transport layer, an electron injection layer, and the like. Further, the light emitting layer may be a single layer or a laminate constituted by a plurality of layers. When the light emitting layer is a plurality of layers, a charge generating layer may be provided between the light emitting layers. The charge generating layer may be constituted by compounds with a lowest unoccupied molecular orbital (LUMO) lower than that of a hole transport layer, and the LUMO of the charge generating layer may be lower than the highest occupied molecular orbital (HOMO) of the hole transport layer. Here, the molecular orbital energy of the organic compound layer may be the molecular orbital energy of organic compounds having the largest weight ratio in the organic compound layer.

Here, the HOMO and the LUMO will be described to be “higher” the closer they are to the vacuum level. The LUMO of the charge generating layer being lower than the HOMO of the hole transport layer indicates that the LUMO of the charge generating layer is closer to the vacuum level than the HOMO of the hole transport layer.

In the present specification, the HOMO and the LUMO can be calculated by molecular orbital calculation. Molecular orbital calculation may be performed according to Density Functional Theory (DFT) or the like and may be performed using B3LYP as a functional, 6-31G* as basis functions, and the like. Molecular orbital calculation can be performed using, for example, Gaussian 09 (Gaussian 09, Revision C.01, M. J. Frisch, G. W. Trucks, H. B. Schlegel, G. E. Scuseria, M. A. Robb, J. R. Cheeseman, G. Scalmani, V. Barone, B. Mennucci, G. A. Petersson, H. Nakatsuji, M. Caricato, X. Li, H. P. Hratchian, A. F. Izmaylov, J. Bloino, G. Zheng, J. L. Sonnenberg, M. Hada, M. Ehara, K. Toyota, R. Fukuda, J. Hasegawa, M. Ishida, T. Nakajima, Y. Honda, O. Kitao, H. Nakai, T. Vreven, J. A. Montgomery, Jr., J. E. Peralta, F. Ogliaro, M. Bearpark, J. J. Heyd, E. Brothers, K. N. Kudin, V. N. Staroverov, R. Kobayashi, J. Normand, K. Raghavachari, A. Rendell, J. C. Burant, S. S. Iyengar, J. Tomasi, M. Cossi, N. Rega, J. M. Millam, M. Klene, J. E. Knox, J. B. Cross, V. Bakken, C. Adamo, J. Jaramillo, R. Gomperts, R. E. Stratmann, O. Yazyev, A. J. Austin, R. Cammi, C. Pomelli, J. W. Ochterski, R. L. Martin, K. Morokuma, V. G. Zakrzewski, G. A. Voth, P. Salvador, J. J. Dannenberg, S. Dapprich, A. D. Daniels, O. Farkas, J. B. Foresman, J. V. Ortiz, J. Cioslowski, and D. J. Fox, Gaussian, Inc., Wallingford CT, 2010.)

The HOMO and the LUMO in the present specification can be calculated using an ionization potential and a band gap. The HOMO can be estimated by measuring the ionization potential. The ionization potential can be measured by a measuring device such as AC-3 after dissolving a compound to be measured in a solvent such as toluene. The band gap can be measured by measurement in which excitation light is applied after dissolving a compound to be measured in a solvent such as toluene. The band gap can be measured by measuring the absorption edge for excitation light. Alternatively, measurement can be made by depositing a compound to be measured on a substrate such as glass by vapor deposition and applying excitation light on an evaporated film. Regarding the measurement, the band gap can be measured by measuring the absorption edge of the absorption spectrum of the evaporated film absorbing the excitation light.

The LUMO can be calculated using the values of the band gap and the ionization potential. The LUMO can be estimated by subtracting the value of ionization potential from that of the band gap.

The LUMO can also be estimated from the reduction potential. For example, one electron reduction potential is estimated by cyclic voltammetry (CV) measurement. The CV measurement is performed, for example, in a 0.1 M tetrabutylammonium perchlorate DMF solution, and measurement can be performed using Ag/Ag+ for a reference electrode, Pt for a counter electrode, and glassy carbon for a working electrode. The LUMO can be estimated by adding a difference between the reduction potential of ferrocene and the obtained reduction potential of the compound to −4.8 eV.

In the organic light emitting element that may be used in the light emitting device according to the present embodiment, when an organic compound is included in the light emitting layer, the light emitting layer may be a layer that is constituted only by an organic compound or a layer that is constituted by an organometallic complex and another compound.

### Configuration of Organic Light Emitting Element

The organic light emitting element is arranged by forming an insulating layer, a first electrode, an organic compound layer, and a second electrode on a substrate. A protective layer, a color filter, a microlens and the like may be arranged on a cathode. When arranging a color filter, a planarization layer may be arranged between the color filter and the protective layer. The planarization layer may be constituted by acrylic resin or the like. It is similar for when arranging a planarization layer between a color filter and a microlens.

### Substrate

Examples of the substrate include quartz, glass, a silicon wafer, resin, metal and the like. Further, switching elements, such as transistors, and wiring are provided on the substrate, and an insulating layer may be provided thereon. Regarding the insulating layer, so long as it is possible to form a contact hole such that wiring can be formed to and from the first electrode and it is possible to ensure insulation from wiring that is not connected, the material does not matter. For example, resin (e.g., polyimide), silicon oxide, silicon nitride, or the like can be used.

### Electrodes

Regarding the electrodes, a pair of electrodes can be used. The pair of electrodes may be an anode and a cathode. When an electric field is applied in a direction in which the organic light emitting element emits light, the electrode with a higher potential is an anode and the other is a cathode. Further, a configuration may be taken in which an electrode for supplying holes to the light emitting layer is an anode and an electrode for supplying electrons is a cathode.

Those with as large a work function as possible are preferable as a constituent material of the anode. For example, a single metal, such as gold, platinum, silver, copper, nickel, palladium, cobalt, selenium, vanadium, or tungsten, or a mixture containing these can be used. Alternatively, an alloy in which these are combined, or a metal oxide, such as tin oxide, zinc oxide, indium oxide, indium tin oxide (ITO), or indium zinc oxide, may be used. Conductive polymers, such as polyaniline, polypyrrole, and polythiophene, can also be used.

Regarding these electrode materials, one kind may be used alone, or two or more kinds may be used in combination. Further, the anode may be constituted by one layer or may be constituted by a plurality of layers.

In the case of a reflective electrode, for example, chromium, aluminum, silver, titanium, tungsten, molybdenum, an alloy or a laminate thereof, or the like, can be used. The above materials can function as a reflective film that does not serve as an electrode. In the case of a transparent electrode, an oxide transparent conductive layer or the like constituted by indium tin oxide (ITO), indium zinc oxide, and the like may be used, but the invention is not limited thereto. Photolithography can be used to form an electrode.

Meanwhile, a material with a small work function is preferable as a constituent material of the cathode. Examples include an alkali metal (e.g., lithium), an alkaline earth metal (e.g., calcium), a single metal (e.g., aluminum, titanium, manganese, silver, lead, or chromium), or a mixture containing these. Alternatively, an alloy obtained by combining these single metals can also be used. For example, magnesium-silver, aluminum-lithium, aluminum-magnesium, silver-copper, zinc-silver, and the like can be used. A metal oxide such as indium tin oxide (ITO) can also be used. Regarding these electrode materials, one kind may be used alone, or two or more kinds may be used in combination. The cathode may have a single-layer configuration or a multi-layer configuration. In particular, it is preferable to use silver, and it is even more preferable to use a silver alloy so as to reduce the aggregation of silver. So long as the aggregation of silver can be reduced, a ratio in the alloy does not matter. For example, silver:other metals may be 1:1, 3:1, or the like.

The cathode may be configured to be a top emission element using an oxide conductive layer such as ITO, or may be configured to be a bottom emission element using a reflective electrode such as aluminum (Al), and is not particularly limited. A method of forming the cathode is not particularly limited, but using direct current and alternating current sputtering and the like leads to excellent film coverage and makes it easier to lower resistance and thus is more preferable.

### Pixel Separation Layer

A pixel separation layer is formed by a silicon nitride (SiN) film, a silicon oxynitride (SiON) film, or a silicon oxide (SiO) film formed using chemical vapor deposition (CVD). In order to increase resistance of the organic compound layer in an in-plane direction, it is preferable that the film thickness of the organic compound layer, in particular, the hole transport layer, is formed to be thin at the side walls of the pixel separation layer. Specifically, by increasing vignetting during vapor deposition by increasing the film thickness of the pixel separation layer and the taper angle of the side walls of the pixel separation layer, it is possible to form the film thickness of the side walls to be thin.

Meanwhile, regarding the pixel separation layer, it is preferable to adjust the taper angle of the side walls of the pixel separation layer and the film thickness of the pixel separation layer such that no gap is formed in the protective layer formed thereon. Since no gap is formed in the protective layer, it is possible to reduce the occurrence of defects in the protective layer. Since the occurrence of defects is reduced in the protective layer, it is possible to reduce a decrease in reliability, such as the occurrence of dark spots and the occurrence of conduction defects of the second electrode.

In a light emitting element that can be applied to the present embodiment, even if the taper angle of the side walls of the pixel separation layer is not steep, it is possible to effectively reduce leakage of charge to adjacent pixels. As a result of studies, it was found that sufficient reduction can be made so long as the taper angle is in a range of 60 degrees or more and 90 degrees or less. It is desirable that the thickness of the pixel separation layer is 10 nm or more and 150 nm or less. In addition, a similar effect can be achieved in a configuration only with pixel electrodes without the pixel separation layer. In this case, however, it is preferable to set the film thickness of the pixel electrode to be half or less of that of the organic layer, or to impart forward taper at the ends of the pixel electrode that is smaller than 60 degrees, since shorting of the organic light emitting element can be reduced thereby.

### Organic Compound Layer

The organic compound layer may be formed by a single layer or a plurality of layers. In a case where a plurality of layers are included, these may be referred to as a hole injection layer, a hole transport layer, an electron blocking layer, a light emitting layer, a hole blocking layer, an electron transport layer or an electron injection layer, depending on the function thereof. The organic compound layer is mainly constituted by organic compounds, but may contain inorganic atoms and inorganic compounds. For example, copper, lithium, magnesium, aluminum, iridium, platinum, molybdenum, zinc, or the like may be included. The organic compound layer may be arranged between the first electrode and the second electrode, and may be arranged in contact with the first electrode and the second electrode.

In the case where a plurality of light emitting layers are included, a charge generating unit may be included between a first light emitting layer and a second light emitting layer. The charge generating unit may include an organic compound with a lowest unoccupied molecular orbital (LUMO) energy of −5.0 eV or less. It is similar for when a charge generating unit is included between the second light emitting layer and a third light emitting layer.

### Protective Layer

A protective layer may be provided on the second electrode. For example, by bonding glass having a moisture absorbent onto the second electrode, it is possible to reduce intrusion of water or the like into the organic compound layer and thereby reduce occurrence of display defects. Further, as another embodiment, a passivation film such as silicon nitride may be provided on the cathode to reduce intrusion of water or the like into the organic compound layer. For example, a configuration may be taken such that formation of the cathode is followed by conveyance to another chamber, without breaking vacuum, whereupon a protective layer is formed through formation of a silicon nitride film having a thickness of 2 μm, by CVD. After film formation by CVD, a protective layer by may be provided by atomic deposition (ALD). The material of the film formed by ALD is not limited, but may be silicon nitride, silicon oxide, aluminum oxide, or the like. Silicon nitride may be further formed by CVD on the film formed by ALD. The film formed by ALD may be thinner than the film formed by CVD, and specifically, may be 50% or less, or 10% or less.

### Color Filter

A color filter may be provided on the protective layer. For example, a color filter in which the size of the organic light emitting element has been taken into account may be provided on another substrate and attached to a substrate on which the organic light emitting element has been provided, or a color filter may be patterned by photolithography onto the protective layer described above. The color filter may be constituted by a polymer.

### Planarization Layer

A planarization layer may be included between the color filter and the protective layer. The planarization layer is provided for the purpose of reducing underlying layer unevenness or, without limiting the purpose, may be referred to as a material resin layer. The planarization layer may be constituted by an organic compound, which may be a low-molecular or high-molecular compound, but is preferably a high-molecular compound.

The planarization layer may be provided above and below the color filter, and the constituent materials thereof may be the same or different. Concrete examples include polyvinylcarbazole resin, polycarbonate resin, polyester resin, ABS resin, acrylic resin, polyimide resin, phenolic resin, epoxy resin, silicone resin and urea resin.

### Microlens

An organic light emitting device that includes the organic light emitting element may include an optical member such as a microlens, on the light emitting side. The microlens may be constituted by acrylic resin, epoxy resin, or the like. The purpose of the microlens may be to increase the amount of light extracted from the organic light emitting device, and to control the direction of the extracted light. The microlens may have a hemispherical shape. In a case where it has a hemispherical shape, there is a tangent line that is parallel to the insulating layer among tangent lines that are in contact with the hemisphere, and the point of contact between that tangent line and the hemisphere is the apex of the microlens. The apex of the microlens can be determined similarly in any cross-sectional diagram. That is, there is a tangent line that is parallel to the insulating layer among tangent lines that are in contact with a semicircle of the microlens in a cross-sectional diagram, and the point of contact between that tangent line and the semicircle is the apex of the microlens.

A midpoint of the microlens can also be defined. Given a hypothetical line segment from the end point of an arc shape to the end point of another arc shape, in a cross section of the microlens, the midpoint of that line segment can be referred to as the midpoint of the microlens. The cross section for discriminating the apex and the midpoint may be a cross section that is perpendicular to the insulating layer.

The microlens includes a first surface with a protruded portion and a second surface opposite to the first surface. It is preferable that the second surface is arranged further on the functional layer side than the first surface. In order to achieve such a configuration, the microlens needs to be formed on the light emitting device. In a case where the functional layer is an organic layer, it is preferable to avoid high-temperature processes in the manufacturing process. In a case where a configuration is taken so as to arrange the second surface further on the functional layer side than the first surface, the glass transition temperatures of all the organic compounds constituting the organic layer are preferably 100° C. or higher, and more preferably 130° C. or higher.

### Counter Substrate

A counter substrate may be included on the planarization layer. The counter substrate is called a counter substrate because it is provided at a position countering the above substrate. Constituent materials of the counter substrate may be the same as those of the above substrate. In a case where the above substrate is assumed as the first substrate, the counter substrate may be the second substrate.

### Organic Layer

An organic compound layer (hole injection layer, hole transport layer, electron blocking layer, light emitting layer, hole blocking layer, electron transport layer, electron injection layer, etc.) constituting the organic light emitting element that may be used in the light emitting device according to the present embodiment are formed according to a method to be described below.

A dry process such as vacuum deposition, ionization deposition, sputtering, or plasma can be used for the organic compound layer constituting the organic light emitting element that may be used in the light emitting device according to the present embodiment. Instead of a dry process, a wet process in which dissolution in an appropriate solvent is performed and a layer is formed according to a known coating method (e.g., spin coating, dipping, casting, LB, inkjet, etc.) can be used.

Here, when a layer is formed by vacuum deposition, solution coating, or the like, crystallization or the like is unlikely to occur, which translates into superior stability over time. In a case where a film is formed by coating, the film can be formed by being combined with appropriate binder resin.

Examples of the above binder resin includes, polyvinylcarbazole resin, polycarbonate resin, polyester resin, ABS resin, acrylic resin, polyimide resin, phenolic resin, epoxy resin, silicone resin, urea resin, and the like, but are not limited thereto.

Regarding the binder resin, one kind may be used alone as a homopolymer or a copolymer, or two or more types may be mixed and used. Additives such as a known plasticizer, antioxidant and ultraviolet absorbent may be further used in combination, as needed.

### Pixel Circuit

The light emitting device may include a pixel circuit connected to the light emitting element. The pixel circuits may be of an active matrix type in which light emissions of a first light emitting element and a second light emitting element are each independently controlled. The active matrix circuit may be voltage-programmed or current-programmed. A driving circuit includes a pixel circuit for each pixel. The pixel circuit may include the light emitting element, a transistor that controls light emission luminance of the light emitting element, a transistor that controls emission timing, a capacitor that holds the gate voltage of the transistor that controls light emission luminance, and a transistor for connection to GND without going through the light emitting element.

The light emitting device includes a display region and a peripheral region arranged surrounding the display region. The display region includes the pixel circuits, and the peripheral region includes a display control circuit. The mobility of the transistors constituting the pixel circuits may be lower than the mobility of the transistors constituting the display control circuit.

The slope of the current-voltage characteristic of the transistors constituting the pixel circuits may be gentler than the slope of the current-voltage characteristic of the transistors constituting the display control circuit. The slope of the current-voltage characteristic can be measured based on a so-called Vg-Ig characteristic.

The transistors constituting the pixel circuits are transistors connected to the light emitting elements such as the first light emitting element.

### Pixel

The organic light emitting device includes a plurality of pixels. The pixel includes sub-pixels that emit colors different from each other. The sub-pixels may have respective red, green, and blue (RGB) emission colors, for example.

The pixel emits light in a region also called a pixel opening. This region is the same as a first region. The pixel opening may be 15 μm or less or 5 μm or more. More specifically, it may be 11 μm, 9.5 μm, 7.4 μm, 6.4 μm, or the like.

The spacing between sub-pixels may be 10 μm or less, and specifically, may be 8 μm, 7.4 μm, or 6.4 μm.

The pixels may take on a known form of arrangement in plan view, and for example, may be in a stripe arrangement, a delta arrangement, a pentile arrangement or a Bayer arrangement. The shape of the sub-pixels in a plan view may be any known shape, such as a rectangle, a quadrilateral (e.g., diamond), a hexagon, or the like. Of course, the shape need not be geometrically precise, and if it is close to that of a rectangle, the shape will be deemed to fall under a rectangle. The shape of the sub-pixel and the pixel arrangement can be used in combination.

### Application of Organic Light Emitting Element According to One Embodiment

The organic light emitting element according to an embodiment can be used as a constituent member of a display device and a lighting device. There are other applications such as an exposure light source of an electrophotographic image forming device, a backlight of a liquid crystal display device, and a light emitting device that includes a color filter in a white light source.

The display device may be an image information processing device that includes an image input unit for inputting image information from an area CCD, a linear CCD, a memory card, or the like and an information processing unit for processing inputted information, such that an inputted image is displayed on a display unit.

A display unit of an image capturing device or an inkjet printer may include a touch panel function. A method of driving the touch panel function may be an infrared method, a capacitance method, a resistive film method, or an electromagnetic induction method, and is not particularly limited. The display device may be used in a display unit of a multi-function printer.

Next, the display device according to the present embodiment will be described with reference to the drawings.

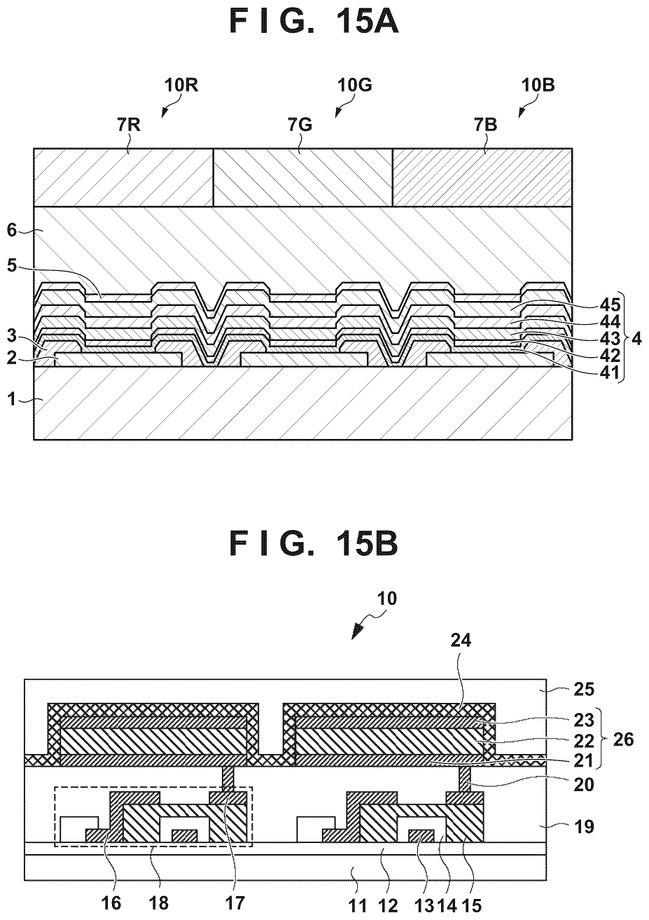

FIGS. 15A and 15B are schematic cross-sectional diagrams illustrating examples of a display device that includes organic light emitting elements and transistors connected to the organic light emitting elements. A transistor is an example of an active element. The transistor may be a thin film transistor (TFT).

FIG. 15A is an example of a pixel that is a component of the display device according to the present embodiment. The pixel includes sub-pixels. The sub-pixels are divided into 10R, 10G, 10B according to light emission thereof. Light emission colors may be distinguished according to wavelengths emitted from the light emitting layer, or selective transmission or color conversion may be performed by a color filter or the like on light emitted from the sub-pixel. Each sub pixel includes, on an interlayer insulating layer 1, a reflective electrode 2 which is the first electrode, an insulating layer 3 which covers the edges of the reflective electrode 2, an organic compound layer 4 which covers the first electrode and the insulating layer, a transparent electrode 5, a protective layer 6, and a color filter 7.

Regarding the interlayer insulating layer 1, a transistor and a capacitor element may be arranged therein or in a layer below. The transistor and the first electrode may be electrically connected via a contact hole or the like (not illustrated).

The insulating layer 3 is also referred to as a bank or a pixel separation film, and covers the edges of the first electrode and is arranged so as to surround the first electrode. A portion where the insulating layer is not arranged contacts the organic compound layer 4 and becomes a light emitting region.

The organic compound layer 4 includes a hole injection layer 41, a hole transport layer 42, a first light emitting layer 43, a second light emitting layer 44, and an electron transport layer 45.

The second electrode 5 may be a transparent electrode, a reflective electrode, or a semi-transmissive electrode.

The protective layer 6 reduces moisture penetration into the organic compound layer. The protective layer is illustrated as a single layer, but may be a plurality of layers. Each layer may be an inorganic compound layer or an organic compound layer.

The color filter 7 is divided into 7R, 7G, and 7B according to colors thereof. The color filter may be formed on a planarization film (not illustrated). Further, there may be a resin protective layer (not illustrated) on the color filter. Further, the color filter may be formed on the protective layer 6, or may be attached after being arranged on a counter substrate, such as a glass substrate.

The display device 10 of FIG. 15B discloses an organic light emitting element 26 and, as an example of a transistor, a TFT 18. An insulating layer 12 is provided on a substrate 11, such as glass or silicon. An active element 18 such as a TFT is arranged on the insulating layer 12, and a gate electrode 13, a gate insulating film 14, and a semiconductor layer 15 of the active element are arranged. In addition, the TFT 18 is constituted by the semiconductor layer 15, a drain electrode 16, and a source electrode 17. An insulating film 19 is provided on the TFT 18. An anode 21 constituting the organic light emitting element 26 and the source electrode 17 are connected via a contact hole 20 provided in the insulating film.

A method of electrically connecting the electrodes (anode and cathode) included in the organic light emitting element 26 and the electrodes (source electrode and drain electrode) included in the TFT is not limited to the embodiment illustrated in FIG. 15B. That is, either the anode or the cathode and either the source electrode or the drain electrode of the TFT need only be electrically connected. The TFT refers to a thin film transistor.

In the display device 10 of FIG. 15B, the organic compound layer is illustrated as a single layer, but the organic compound layer 22 may be a plurality of layers. A first protective layer 24 and a second protective layer 25 for reducing the degradation of the organic light emitting element is provided on the cathode 23.

In the display device 10 of FIG. 15B, a transistor is used as a switching element, but another switching element may be used in place thereof.

Further, the transistor to be used in the display device 10 of FIG. 15B is not limited to a transistor in which a monocrystalline silicon wafer is used and may be a thin film transistor that includes an active layer on the insulating surface of the substrate. As the active layer, there are monocrystalline silicon, amorphous silicon, and non-monocrystalline silicon (e.g., microcrystalline silicon), indium zinc oxide, and non-monocrystalline oxide semiconductor (e.g., indium gallium zinc oxide). A thin film transistor is also referred to as a TFT element.

The transistor included in the display device 10 of FIG. 15B may be formed in the substrate such as an Si substrate. Being formed in the substrate means that the transistor is formed by processing the substrate itself such as an Si substrate. That is, including the transistor in the substrate can also be seen as forming the substrate and the transistor in an integrated manner.

Regarding the organic light emitting element according to the present embodiment, light emission luminance is controlled by a TFT, which an example of a switching element, and by providing a plurality of organic light emitting elements in the surface, it is possible to display an image according to the respective light emission luminances. The switching element according to the present embodiment is not limited to a TFT and may be a transistor formed by low-temperature polysilicon or an active matrix driver formed on the substrate such as an Si substrate. On the substrate can also be said to be in the substrate. Whether to provide a transistor in the substrate or to use a TFT is selected according to the size of a display unit, and for example, if the size is about 0.5 inches, it is preferable to provide the organic light emitting element on an Si substrate.

### Example of Application of Light Emitting Device

An example of applying the light emitting device according to the first to sixth embodiments to a device will be described below. FIG. 16 is a schematic diagram illustrating an example of a display device in which the light emitting device according to the first to sixth embodiments may be used. A display device 1000 may include a touch panel 1003, a display panel 1005, a frame 1006, a circuit board 1007, and a battery 1008 between a top cover 1001 and a bottom cover 1009. Flexible printed circuits (FPCs) 1002 and 1004 are connected to the touch panel 1003 and the display panel 1005. Transistors are printed on the circuit board 1007. The battery 1008 need not be provided if the display device is not a mobile device or may be provided in another position even if the device is a mobile device.

The display device according to the present embodiment may include red, green, and blue color filters. The red, green, and blue color filters may be arranged in a delta arrangement.

The display device according to the present embodiment may be used in a display unit of a mobile terminal. In that case, both a display function and an operation function may be included. Examples of the mobile terminal include a mobile phone (e.g., a smartphone), a tablet, a head-mounted display, and the like.

The display device according to the present embodiment may be used in a display unit of an image capturing device that includes an optical unit including a plurality of lenses and an image capturing element for receiving light that has passed through the optical unit. The image capturing device may include a display unit for displaying information obtained by the image capturing element. The display unit may be a display unit that is exposed to the outside of the image capturing device or may be a display unit arranged in a viewfinder. The image capturing device may be a digital camera or a digital video camera.

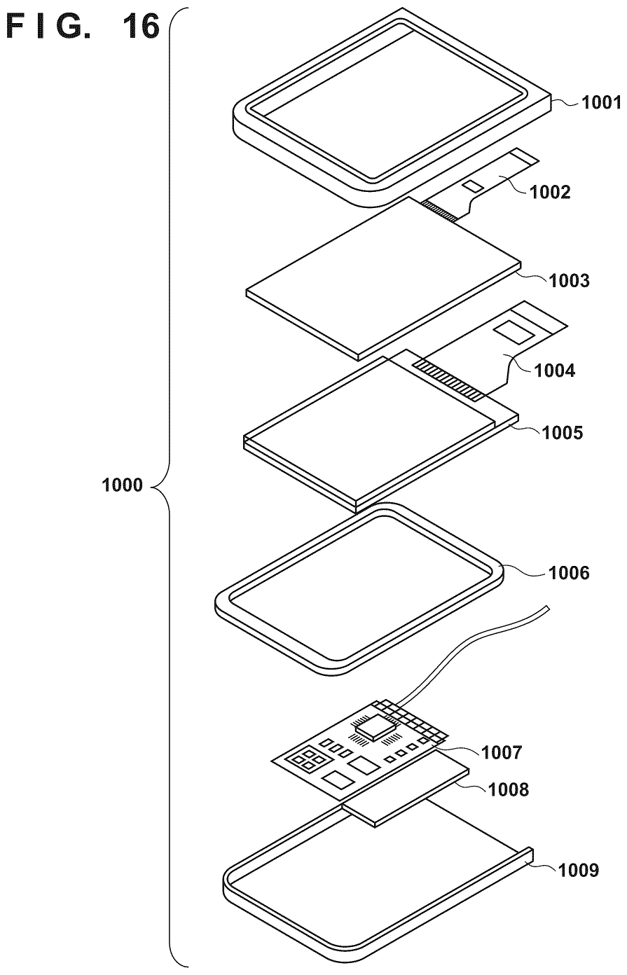

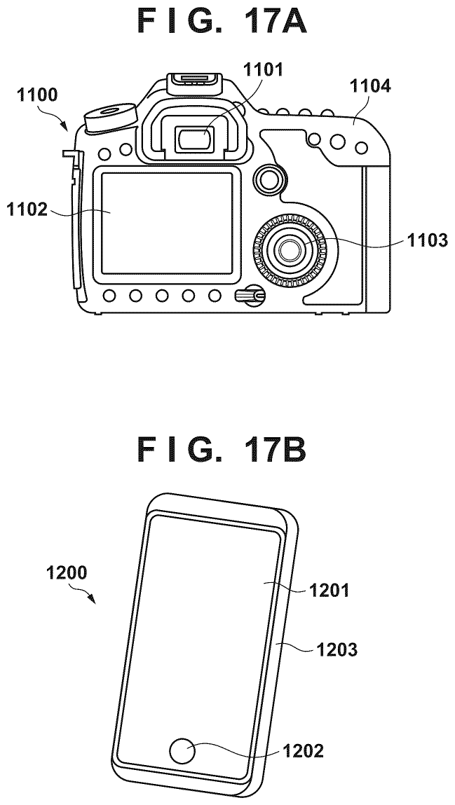

FIG. 17A is a schematic diagram illustrating an example of an image capturing device according to the present embodiment. An image capturing device 1100 may include a viewfinder 1101, a rear display 1102, an operation unit 1103, and a housing 1104. The viewfinder 1101 may include the display device according to the present embodiment. In that case, the display device may display not only an image to be captured but also environmental information, an image capturing instruction, and the like. The environmental information may be an intensity of external light, a direction of external light, a speed at which a subject moves, a possibility that a subject may be blocked by an obstacle, and the like.

Since a time that is suitable for image capturing is a short time, it is better that information is displayed as soon as possible. Therefore, it is preferable to use a display device in which the light emitting device of the present disclosure is used. It is because an organic light emitting element has a fast response speed, and the light emitting device according to the present embodiment has a short settling time for potential variation at the time of signal input. The display device according to the present embodiment can be used more suitably than a liquid crystal display device in these devices that require fast display speed.

The image capturing device 1100 includes an optical unit (not illustrated). The optical unit includes a plurality of lenses and forms an image on an image capturing element which is accommodated in the housing 1104. Regarding the plurality of lenses, focus can be adjusted by adjusting their relative positions. This operation can also be performed automatically. The image capturing device may be referred to as a photoelectric conversion device. The photoelectric conversion device can include, as image capturing methods, a method of detecting a difference from a previous image rather than performing sequential image capturing, a method of extraction from a continuously recorded image, and the like.

FIG. 17B is a schematic diagram illustrating an example of an electronic device according to the present embodiment. An electronic device 1200 includes a display unit 1201, an operation unit 1202, and a housing 1203. The housing 1203 may include a circuit, a printed circuit board that includes such a circuit, a battery, and a communication unit. The operation unit 1202 may be a button or a touch panel type sensing unit. The operation unit may include a biometric authentication unit that, for example, recognizes a fingerprint and unlocks the lock. The electronic device that includes a communication unit can also be referred to as a communication device. The electronic device may further include a camera function by including a lens and an image capturing element. An image captured using the camera function is displayed on the display unit. Examples of the electronic device include a smartphone, a notebook computer, and the like.

FIGS. 18A and 18B are schematic diagrams illustrating examples of the display device according to the present embodiment. FIG. 18A is a display device, such as a TV monitor or a PC monitor. A display device 1300 includes a frame 1301 and a display unit 1302. The light emitting device according to the present embodiment may be used in the display unit 1302.

The frame 1301 and a base 1303, which supports the display unit 1302, are included. The base 1303 is not limited to the form of FIG. 18A. The lower side of the frame 1301 may also serve as a base.

The frame 1301 and the display unit 1302 may be curved. The radius of curvature thereof may be 5000 mm or more and 6000 mm or less.

FIG. 18B is a schematic diagram illustrating another example of the display device according to the present embodiment. A display device 1310 of FIG. 18B is configured to be foldable, and is a so-called foldable display device. The display device 1310 includes a first display unit 1311, a second display unit 1312, a housing 1313, and a bending point 1314. The first display unit 1311 and the second display unit 1312 may include the light emitting device according to the present embodiment. The first display unit 1311 and the second display unit 1312 may be a single display device without a joint. The first display unit 1311 and the second display unit 1312 can be divided at the bending point. The first display unit 1311 and the second display unit 1312 may each display a different image, or the first and second display units may display one image.

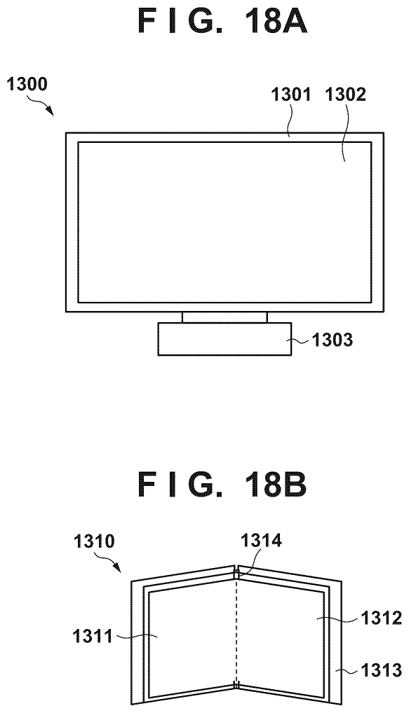

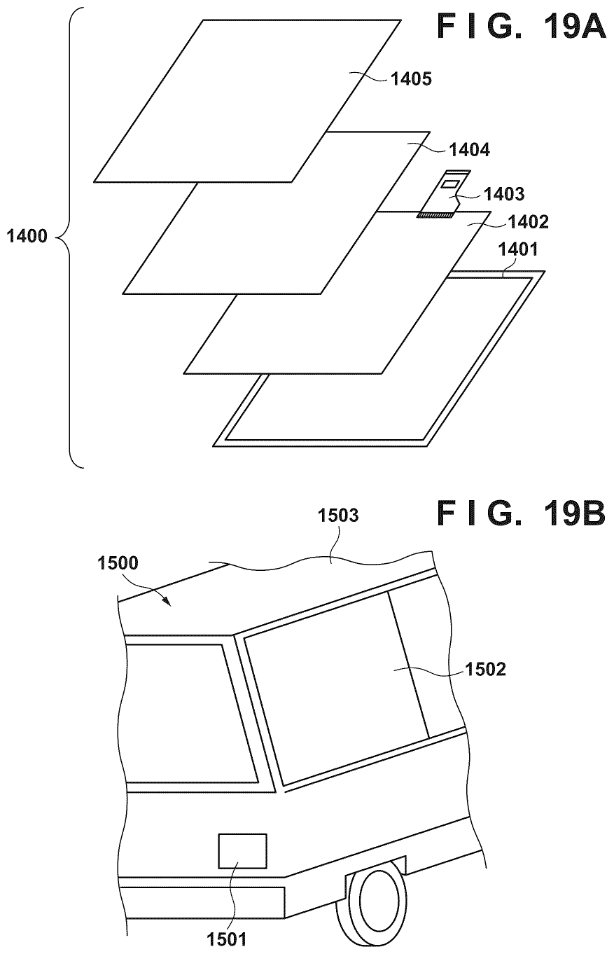

FIG. 19A is a schematic diagram illustrating an example of a lighting device according to the present embodiment. A lighting device 1400 may include a housing 1401, a light source 1402, a circuit board 1403, an optical film 1404, and a light diffusion unit 1405. The light source includes the organic light emitting element according to the present embodiment. The optical filter may be a filter that enhances the color rendering of the light source. The light diffusion unit can effectively diffuse the light of the light source, such as illumination, and deliver light over a wide range. The optical filter and the light diffusion unit may be provided on the light emitting side of the lighting. If necessary, a cover may be provided on the outermost portion.

The lighting device is, for example, a device for illuminating a room. The lighting device may emit white, daylight white, or any other color from blue to red, and may have a light control circuit for controlling these. The lighting device may include the organic light emitting element according to the present disclosure and a power supply circuit connected thereto. The power supply circuit is a circuit for converting an AC voltage into a DC voltage. Further, white has a color temperature of 4200 K, and daylight white has a color temperature of 5000 K. The lighting device may include a color filter.

Further, the lighting device according to the present embodiment may include a heat dissipation unit. The heat dissipation unit releases the heat inside the device to the outside of the device, and examples include metal with a high specific heat, liquid silicon, and the like.

FIG. 19B is a schematic diagram of a vehicle, which is an example of a moving body according to the present embodiment. The vehicle includes a tail lamp, which is an example of a lamp. A vehicle 1500 includes a tail lamp 1501 and may take a form in which the tail lamp is lit at the time of a brake operation or the like is performed.

The tail lamp 1501 may include the organic light emitting element according to the present embodiment. The tail lamp may include a protective member that protects the organic light emitting element. The protective member has a certain degree of high strength and is preferably constituted by polycarbonate or the like although the material does not matter so long as it is transparent. The polycarbonate may be mixed with a furandicarboxylic acid derivative, an acrylonitrile derivative, or the like.

The vehicle 1500 may include a vehicle body 1503 and a window 1502 attached thereto. If not a window for confirming what is ahead and behind the vehicle, the window may be a transparent display. The transparent display may include the organic light emitting element according to the present embodiment. In this case, a constituent material such as an electrode included in the organic light emitting element is constituted by a transparent member.

The moving body according to the present embodiment may be a ship, an aircraft, a drone, or the like. The moving body may include a body and a lamp arranged in the body. The lamp may emit light to inform the position of the body. The lamp includes the organic light emitting element according to the present embodiment.

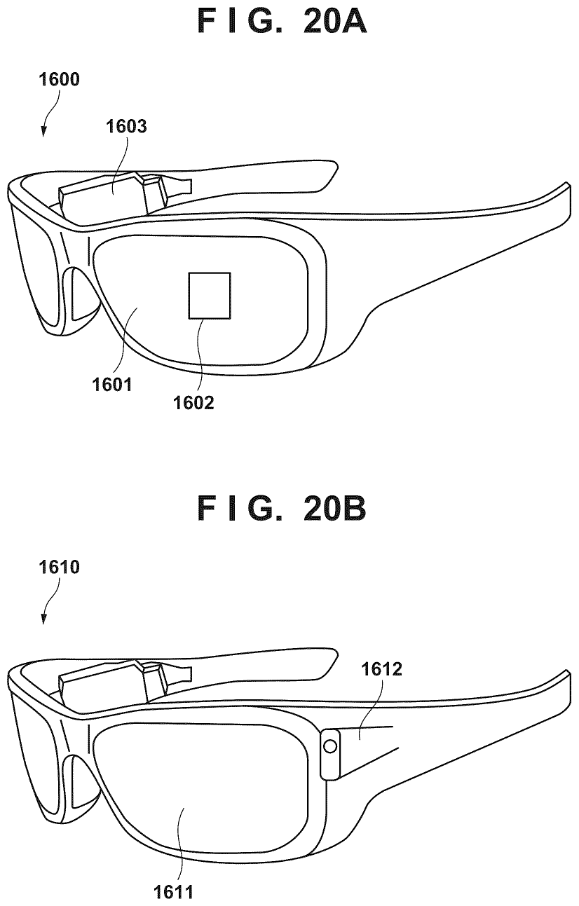

An example of application of the display device of each of the above embodiments will be described with reference to FIGS. 20A and 20B. The display device can be applied to a system that can be worn as a wearable device, such as smart glasses, an HMD, or smart contact lenses. An image capturing display device to be used in such an application example includes an image capturing device capable of photoelectric conversion of visible light and a display device capable of emitting visible light.

FIG. 20A illustrates glasses 1600 (smart glasses) according to one application example. An image capturing device 1602 such as a CMOS sensor or a SPAD is provided on the front side of a lens 1601 of the glasses 1600. Further, the display device according to each of the above embodiments is provided on the back surface side of the lens 1601.

The glasses 1600 further include a control device 1603. The control device 1603 functions as a power source for supplying power to the image capturing device 1602 and the display device according to each of the embodiments. Further, the control device 1603 controls the operation of the image capturing device 1602 and the display device. An optical system for focusing light in the image capturing device 1602 is formed on the lens 1601.

FIG. 20B illustrates glasses 1610 (smart glasses) according to one application example. The glasses 1610 include a control device 1612. The control device 1612 is provided with an image capturing device corresponding to the image capturing device 1602 and the display device. An optical system for projecting light emitted by the display device in the control device 1612 is formed in a lens 1611, and an image is projected onto the lens 1611. The control device 1612 functions as a power source for supplying power to the image capturing device and the display device, and controls the operation of the image capturing device and the display device. The control device may include a gaze detection unit that detects a gaze of the wearer. Infrared light may be used to detect the gaze. An infrared light emitting unit emits infrared light to an eye of the user gazing at a display image. By the image capturing unit that includes a light receiving element detecting the emitted infrared light reflected from the eye, a captured image of the eye is obtained. By including a reduction unit for reducing the light from the infrared light emitting unit to the display unit in plan view, a decrease in image quality is reduced.

The gaze of the user on the display image is detected from the captured image of the eye obtained by the imaging of the infrared light. Any known technique can be used for detecting a gaze using a captured image of the eye. As an example, a gaze detection method based on a Purkinje image according to reflection of illumination light at the cornea can be used.

More specifically, gaze detection processing based on a pupil corneal reflection method is performed. The gaze of the user is detected by calculating a eye vector representing the direction (rotation angle) of the eye based on a Purkinje image and an image of the pupil included in the captured image of the eye, using the pupil corneal reflection method.

The display device according to the present embodiment may include an image capturing device that includes a light receiving element and control a display image of the display device based on the user's gaze information from the image capturing device.

Specifically, regarding the display device, the first display region at which the user gazes and the second display region other than the first display region are determined based on the gaze information. Regarding the first display region and the second display region, they may be determined by the control device of the display device, or what has been determined by an external control device may be received. In the display region of the display device, the display resolution of the first display region may be controlled to be higher than the display resolution of the second display region. That is, the resolution of the second display region may be lower than that of the first display region.

Further, the display region includes the first display region and the second display region different from the first display region, and a region with high priority is determined from the first display region and the second display region based on the gaze information. Regarding the first display region and the second display region, they may be determined by the control device of the display device, or what has been determined by an external control device may be received. The resolution of a region with high priority may be controlled at higher resolution than the resolution of a region other than the region with high priority. That is, the resolution of a region with relatively low priority may be decreased.

Artificial Intelligence (AI) may be used to determine the first display region and a region with high priority. AI may be a model configured to estimate an angle of gaze and a distance to an object ahead of the gaze from an image of the eye using images of the eye and the directions in which the eye in the image was actually looking as teacher data. An AI program may be included in the display device, the image capturing device, or an external device. If it is included in the external device, it is communicated to the display device by communication.

In a case of display control based on gaze detection, it can be preferably applied to smart glasses further having an image capturing device for imaging the outside. The smart glasses can display the captured external information in real time.

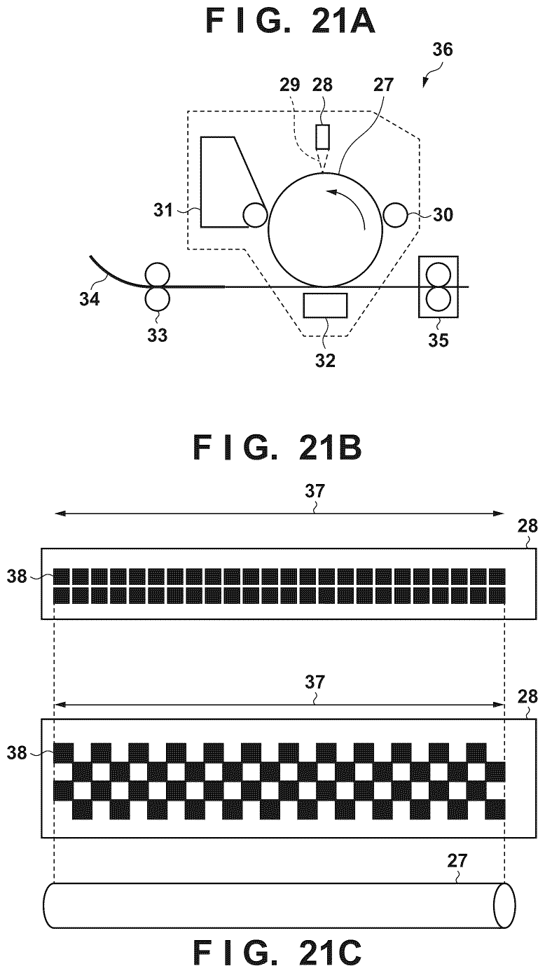

FIGS. 21A to 21C represent an image forming device according to the present embodiment. FIG. 21A is a schematic diagram of an image forming device 36 according to the present embodiment. The image forming device includes a photosensitive body 27, an exposure light source 28, a developing unit 31, a charging unit 30, a transfer device 32, a conveyance roller 33, and a fixing device 35.

Light 29 is irradiated from an exposure light source 28 to form an electrostatic latent image on the surface of a photosensitive body 27. The exposure light source includes the light emitting device according to the present disclosure. A developing unit 31 includes toner and the like. A charging unit 30 charges the photosensitive body. A transfer device 32 transfers a developed image onto a recording medium 34. A conveyance roller 33 conveys the recording medium 34. The recording medium 34 is, for example, paper. A fixing unit 35 fixes an image formed on the printing medium.

FIGS. 21B and 21C are schematic diagrams illustrating states in which a plurality of light emitting units 38 of the exposure light source 28 are arranged on a long substrate. The light emitting units 38 are indicated by black squares. Reference numeral 37 is a direction parallel to the axis of the photosensitive body 27 and represents a column direction in which the organic light emitting elements are arranged. The column direction is the same as the direction of the axis of rotation of the photosensitive body 27. This direction may also be referred to as the long axis direction of the photosensitive body 27.

FIG. 21B is a form in which the light emitting units 38 are arranged in a long axis direction of the photosensitive body 27. FIG. 21C is a form different from that of FIG. 21B and is a form in which the light emitting units 38 are alternately arranged in a column direction in each of a first column and a second column. The light emitting units 38 of the first column and the light emitting units 38 of the second column are arranged at different positions in the row direction.

In the first column, a plurality of light emitting units are arranged at intervals. The second column includes light emitting units at positions corresponding to the gaps between the light emitting units of the first column. That is, a plurality of light emitting units are arranged at intervals also in a row direction.

The arrangement of FIG. 21C can be reworded, for example, as being in a state of grid arrangement, a state of staggered grid arrangement, or in a checkered pattern.

As described above, by using a device in which the organic light emitting element according to the present embodiment is used, it is possible to perform display with excellent image quality that is stable for for a long time can be achieved.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-221460, filed Dec. 27, 2023, which is hereby incorporated by reference herein in its entirety.

What is claimed is:

1. A light emitting device comprising:
a plurality of light emitting elements arranged in a plurality of rows and a plurality of columns;
a signal output circuit configured to drive the plurality of light emitting elements; and
a voltage generating circuit configured to output a set of voltage signals, wherein
the signal output circuit includes a plurality of column circuits configured to respectively drive a plurality of light emitting elements in a corresponding column among the plurality of columns, and
each column circuit includes a voltage holding circuit configured to hold voltages corresponding to the set of voltage signals supplied from the voltage generating circuit and a digital-to-analog converter configured to convert an inputted digital signal to an analog signal using a voltage among the voltages held in the voltage holding circuit.

2. The light emitting device according to claim 1, further comprising:
a pre-charge circuit configured to pre-charge output of the digital-to-analog converter to a predetermined voltage before the held voltage among the voltages corresponding to the set of voltage signals is supplied to the digital-to-analog converter.

3. The light emitting device according to claim 1, wherein
the voltage holding circuit holds the voltages corresponding to the set of voltage signals in a plurality of capacitor elements.

4. The light emitting device according to claim 3, wherein
the set of voltage signals are supplied to the plurality of capacitor elements at different timings.

5. The light emitting device according to claim 1, wherein
the voltage holding circuit, after being connected with the voltage generating circuit and holding the voltages corresponding to the set of voltage signals, disconnects the connection and supplies the held voltage among voltages corresponding to the set of voltage signals to the digital-to-analog converter.

6. The light emitting device according to claim 1, wherein
the set of voltage signals include a plurality of voltage signals.

7. The light emitting device according to claim 1, wherein
the voltage holding circuit is shared among at least two column circuits among the plurality of column circuits.

8. The light emitting device according to claim 1, wherein
the digital-to-analog converter includes a resistor string configured to divide the set of voltage signals.

9. The light emitting device according to claim 1, wherein
the voltage holding circuit supplies the held voltage among the voltages corresponding to the set of voltages to the digital-to-analog converter via a buffer circuit.

10. A photoelectric conversion device comprising:
an optical unit including a plurality of lenses;
an image capturing element configured to receive light that has passed through the optical unit; and
a display unit configured to display an image captured by the image capturing element,
wherein the display unit includes the light emitting device according to claim 1.

11. An electronic device comprising:
a display unit including the light emitting device according to claim 1;
a housing in which the display unit is arranged; and
a communication unit provided in the housing and configured to communicate with an external unit.

12. A lighting device comprising:
a light source including the light emitting device according to claim 1; and
a light diffusion unit or an optical film configured to transmit light emitted by the light source.

13. A moving body comprising:
a lamp including the light emitting device according to claim 1; and
a body in which the lamp is provided.
